(19) United States
(12) Patent Application Publication
(10) Pub. No.: US 2016/0011449 A1
(43) Pub. Date: Jan. 14, 2016

(54) Liquid Crystal Display and Optical Compensation Method Applied in Liquid Crystal Display

(71) Applicant: Shenzhen China Star Optoelectronics Technology Co., Ltd., Guangdong (CN)

(72) Inventors: Chihtsung KANG, Guangdong (CN); Bo HAI, Guangdong (CN)

(73) Assignee: Shenzhen China Star Optoelectronics Technology Co., Ltd., Guangdong (CN)

(21) Appl. No.: 14/379,702

(22) PCT Filed: Jul. 2, 2014
(86) PCT No.: PCT/CN2014/081468

§ 371 Date: Aug. 19, 2014

(30) Foreign Application Priority Data
Jun. 25, 2014 (CN) 201410290951.7

(51) Int. Cl. G02F 1/13363; G02F 1/1335

(52) U.S. Cl. CPC G02F 1/13363; G02F 1/133528; G02F 1/133634; G02F 2413/11

(57) ABSTRACT

The present invention provides an LCD and an optical compensating method applied in the LCD. By changing compensation values of an uniaxial positively birefringent A-Plate and an uniaxial negatively birefringent C-Plate, especially the compensation value Rth of the uniaxial negatively birefringent C-Plate, the present invention weakens leakage light under wide viewing angle; embodying the present invention can effectively increase wide viewing angle contrast ratio and resolution.

### CROSS REFERENCE TO RELATED APPLICATION

The present application is based on, and claims priority from, Chinese application number 201410290951.7, filed Jun. 25, 2014, the disclosure of which is hereby incorporated by reference herein in its entirety.

### BACKGROUND OF THE INVENTION

1. Field of the Invention

The present invention relates to a liquid crystal display (LCD) technology field, more particularly, to an LCD panel and an optical compensation method thereof.

2. Description of the Prior Art

As LCD panels continuously dissipate, demand for LCD panels of high quality is rising. To achieve higher liquid crystal optical path difference (OPD), cell gap of liquid crystal has to increase when refractivity is fixed, which leads to increase of liquid crystal consumption. As liquid crystal is very costly, the more consumption of liquid crystal, the higher producing cost is.

Moreover, OPD not only relates to index of transmissivity, but also affects wide viewing angle leakage light. Take thin film transistor (TFT) LCD for instance. As observation angle of TFT-LCD increases, image contrast ratio continuously decreases, in the meanwhile image resolution gradually declines. That is because birefringence of liquid crystal molecules in a liquid crystal layer floats due to change of observation angle. If compensated by a wide viewing angle compensation film, leakage light can be effectively cut down, so that image contrast ratio can be greatly raised within a given angle,

The compensation principle of the compensation film is to revise phase difference of liquid crystal in different angles, so that birefringence property of liquid crystal molecules can be correspondingly compensated.

According to different liquid crystal display models, applying compensation films are different. Large size liquid crystal televisions generally apply vertical alignment (VA) compensation films, such as N-TAC of Konica in early stage, and Zeonor of OPOTES, F-TAC series of Fujitsu, X-Plate of Nitto Denko, etc.

When liquid crystal OPD stays the same, if compensation values of compensation films are different, wide viewing angle leakage light and contrast ratio are different accordingly. Please refer to FIG. 1 and FIG. 2. FIG. 1 is an isoluminance contour diagram of compensation leakage light of an uniaxial positively birefringent A-Plate and an uniaxial negatively birefringent C-Plate in conventional art; FIG. 2 is a full-view equal contrast ratio contour diagram of A-Plate and C-plate after compensation in conventional art, whereof compensation values of the A-Plate and the C-Plate are stated in the bellowing chart:

| OPD | A-Plate Ro | A-Plate Rth | C-Plate Rth |
|---|---|---|---|
| 305 nm | 109.2 nm | 54.6 nm | 402.6 nm |

FIG. 1 and FIG. 2 show that when compensation values of A-Plate and C-Plate in conventional art are applied, leakage light under wide viewing angle observation occurs, wide viewing angle contrast ratio declines, observation range becomes smaller.

Therefore, technical problems above mentioned await solution.

### SUMMARY OF THE INVENTION

The primary object of the present invention is to provide an LCD panel and an optical compensation method thereof, to solve the problem of severe leakage light under wide viewing angle observation given compensation values of A-Plate and C-Plate in conventional art, and the problem of low contrast ratio under wide viewing angle and small observation range.

According to the present invention, a liquid crystal display (LCD) device where a range of a liquid crystal optical path difference (OPD) LCΔND of the LCD is 287 nm≦LCΔND≦305 nm is proposed. The LCD comprises: a first substrate; a second substrate; a liquid crystal layer set up between the first substrate and the second substrate; a first polarizing film set up on the outside of the first substrate; a second polarizing film set up on the outside of the second substrate; an uniaxial positively birefringent A-Plate; and an uniaxial negatively birefringent C-Plate, the uniaxial positively birefringent A-Plate and the uniaxial negatively birefringent C-Plate set up between the first substrate and the first polarizing film, or between the second substrate and the second polarizing film; where a range of an in-plane OPD compensation value Ro of the uniaxial positively birefringent A-Plate is 92 nm≦Ro≦184 nm, a range of an out-plane OPD compensation value Rth of the uniaxial positively birefringent A-Plate -is 46 nm≦Rth≦92 nm; a range of a compensation value of the uniaxial negatively birefringent C-Plate is Y1≦Rth≦Y2; where Y1 and Y2 satisfy the following formulas:

Y1=−0.00003316x³+0.08074x²−10.84x+520.2;

Y2=−0.00005073x⁴+0.013658x³−1.3931x²+63.85x−853.5;

X is the out-plane OPD compensation value Rth of the uniaxial positively birefringent A-Plate out-plane OPD compensation value Rth.

In one aspect of the present invention, the range of the in-plane OPD compensation value Ro of the uniaxial positively birefringent A-Plate and the range of the out-plane OPD compensation value Rth of the uniaxial positively birefringent A-Plate are acquired through the following formulas:

Ro=(Nx−Ny)*d1; and

Rth=[(Nx+Ny)/2−Nz]*d1

where Nx is the highest refractivity which an in-plane of the uniaxial positively birefringent A-Plate can provide in direction X; Ny is the refractivity of direction Y of the uniaxial positively birefringent A-Plate which direction X is perpendicular with; Nz is the refractivity of a thickness direction of the uniaxial positively birefringent A-Plate; d1 is the thickness of the uniaxial positively birefringent A-Plate; Nx>Ny, Ny=Nz.

In another aspect of the present invention, the range of the compensation value Rth of the uniaxial negatively birefringent C-Plate is acquired through the following formula:

Rth=[(Mx+My)/2−Mz]*d2;

where Mx is the highest refractivity which the in-plane of the uniaxial negatively birefringent C-Plate can provide in direction X; My is the refractivity of direction Y of the uniaxial negatively birefringent C-Plate which direction X is perpendicular with; Mz is the refractivity of the thickness direction of the uniaxial negatively birefringent C-Plate; d2 is the thickness of the uniaxial negatively birefringent C-Plate; Mx=My, My>Mz.

In still another aspect of the present invention, the uniaxial positively birefringent A-Plate and the uniaxial negatively birefringent C-Plate are set up on the same side of the liquid crystal layer and between the first substrate and the first polarizing film.

In yet another aspect of the present invention, the uniaxial positively birefringent A-Plate and the uniaxial negatively birefringent C-Plate are set up on the same side of the liquid crystal layer, and between the second substrate and the second polarizing film.

According to the present invention, a liquid crystal display (LCD) device comprises: a first substrate; a second substrate; a liquid crystal layer set up between the first substrate and the second substrate; a first polarizing film set up on the outside of the first substrate; a second polarizing film set up on the outside of the second substrate; an uniaxial positively birefringent A-Plate; and an uniaxial negatively birefringent C-Plate, the uniaxial positively birefringent A-Plate and the uniaxial negatively birefringent C-Plate set up between the first substrate and the first polarizing film, or between the second substrate and the second polarizing film; where a range of an in-plane OPD compensation value Ro of the uniaxial positively birefringent A-Plate is 92 nm≦Ro≦184 nm, a range of an out-plane OPD compensation value Rth of the uniaxial positively birefringent A-Plate -is 46 nm≦Rth≦92 nm; a range of a compensation value of the uniaxial negatively birefringent C-Plate is Y1≦Rth≦Y2; where Y1 and Y2 satisfy the following formulas:

Y1=−0.00003316x³+0.08074x²−10.84x+520.2;

Y2=−0.00005073x⁴+0.013658x³−1.3931x²+63.85x−853.5;

X is the out-plane OPD compensation value Rth of the uniaxial positively birefringent A-Plate out-plane OPD compensation value Rth.

In one aspect of the present invention, the range of the in-plane OPD compensation value Ro of the uniaxial positively birefringent A-Plate and the range of the out-plane OPD compensation value Rth of the uniaxial positively birefringent A-Plate are acquired through the following formulas:

Ro=(Nx−Ny)*d1; and

Rth=[(Nx+Ny)/2−Nz]*d1

where Nx is the highest refractivity which an in-plane of the uniaxial positively birefringent A-Plate can provide in direction X; Ny is the refractivity of direction Y of the uniaxial positively birefringent A-Plate which direction X is perpendicular with; Nz is the refractivity of a thickness direction of the uniaxial positively birefringent A-Plate; d1 is the thickness of the uniaxial positively birefringent A-Plate; Nx>Ny, Ny=Nz.

In another aspect of the present invention, the range of the compensation value Rth of the uniaxial negatively birefringent C-Plate is acquired through the following formula:

Rth=[(Mx+My)/2−Mz]*d2;

where Mx is the highest refractivity which the in-plane of the uniaxial negatively birefringent C-Plate can provide in direction X; My is the refractivity of direction Y of the uniaxial negatively birefringent C-Plate which direction X is perpendicular with; Mz is the refractivity of the thickness direction of the uniaxial negatively birefringent C-Plate; d2 is the thickness of the uniaxial negatively birefringent C-Plate; Mx=My, My>Mz.

In still another aspect of the present invention, the uniaxial positively birefringent A-Plate and the uniaxial negatively birefringent C-Plate are set up on the same side of the liquid crystal layer and between the first substrate and the first polarizing film.

In yet another aspect of the present invention, the uniaxial positively birefringent A-Plate and the uniaxial negatively birefringent C-Plate are set up on the same side of the liquid crystal layer, and between the second substrate and the second polarizing film.

According to the present invention, an optical compensation method for an LCD, comprises: adjusting a range of an in-plane OPD compensation value of a uniaxial positively birefringent A-Plate as 92 nm≦Ro≦184 nm; adjusting a range of an out-plane OPD compensation value of an uniaxial positively birefringent A-Plate as 46 nm≦Rth≦92 nm; and adjusting a range of a compensation value Rth of an uniaxial negatively birefringent C-Plate as Y1≦Rth≦Y2, where Y1 and Y2 satisfy the following formulas:

Y1=−0.00003316x³+0.08074x²−10.84x+520.2; and

Y2=−0.00005073x⁴+0.013658x³−1.3931x²+63.85x−853.5;

where X is the out-plane OPD compensation value Rth of the uniaxial positively birefringents A-Plate; the uniaxial positively birefringent A-Plate and the uniaxial negatively birefringent C-Plate are set up between the second substrate and the second polarizing film.

In one aspect of the present invention, the range of the in-plane OPD compensation value Ro of the uniaxial positively birefringent A-Plate and the range of the out-plane OPD compensation value Rth of the uniaxial positively birefringent A-Plate are acquired through the following formulas:

Ro=(Nx−Ny)*d1; and

Rth=[(Nx+Ny)/2−Nz]*d1

where Nx is the highest refractivity which an in-plane of the uniaxial positively birefringent A-Plate can provide in direction X; Ny is the refractivity of direction Y of the uniaxial positively birefringent A-Plate which direction X is perpendicular with; Nz is the refractivity of a thickness direction of the uniaxial positively birefringent A-Plate; d1 is the thickness of the uniaxial positively birefringent A-Plate; Nx>Ny, Ny=Nz.

In another aspect of the present invention, the range of the compensation value Rth of the uniaxial negatively birefringent C-Plate is acquired through the following formula:

Rth=[(Mx+My)/2−Mz]*d2;

where Mx is the highest refractivity which the in-plane of the uniaxial negatively birefringent C-Plate can provide in direction X; My is the refractivity of direction Y of the uniaxial negatively birefringent C-Plate which direction X is perpendicular with; Mz is the refractivity of the thickness direction of the uniaxial negatively birefringent C-Plate; d2 is the thickness of the uniaxial negatively birefringent C-Plate; Mx=My, My>Mz.

In still another aspect of the present invention, the uniaxial positively birefringent A-Plate and the uniaxial negatively birefringent C-Plate are set up on the same side of the liquid crystal layer and between the first substrate and the first polarizing film.

In yet another aspect of the present invention, the uniaxial positively birefringent A-Plate and the uniaxial negatively birefringent C-Plate are set up on the same side of the liquid crystal layer, and between the second substrate and the second polarizing film.

By changing compensation values of an uniaxial positively birefringent A-Plate and an uniaxial negatively birefringent C-Plate, the present invention weakens leakage light under wide viewing angle; embodying the present invention can effectively increase wide viewing angle (not a horizontal or vertical azimuth) contrast ratio and resolution.

These and other features, aspects and advantages of the present disclosure will become understood with reference to the following description, appended claims and accompanying figures.

### BRIEF DESCRIPTION OF THE DRAWINGS

FIG. 1 indicates luminance distribution chart of black-state light leakage adopting an A-plate and a C-plate cooperating with a compensation value in a prior art.

FIG. 2 indicates contrast distribution chart of the corresponding full-view adopting an A-plate and a C-plate cooperating with a compensation value in a prior art.

FIG. 3 shows a schematic diagram of a liquid crystal display according to a first embodiment of the present invention.

FIG. 4 shows a schematic diagram of a liquid crystal display according to a second embodiment of the present invention.

FIG. 5 and FIG. 6 indicate diagrams of curves of the changing amount of light leakage with retardation values.

FIG. 7 indicates luminance distribution chart of black-state light leakage adopting an A-plate and a C-plate cooperating with a compensation value according to a preferred embodiment of the present invention.

FIG. 8 indicates contrast distribution chart of the corresponding full-view adopting an A-plate and a C-plate cooperating with a compensation value according to a preferred embodiment of the present invention.

FIG. 9 indicates luminance distribution chart of black-state light leakage adopting an A-plate and a C-plate cooperating with a compensation value according to another preferred embodiment of the present invention.

FIG. 10 indicates contrast distribution chart of the corresponding full-view adopting an A-plate and a C-plate cooperating with a compensation value according to another preferred embodiment of the present invention.

FIG. 11 indicates luminance distribution chart of black-state light leakage adopting an A-plate and a C-plate cooperating with a compensation value according to various preferred embodiment of the present invention.

FIG. 12 indicates contrast distribution chart of the corresponding full-view adopting an A-plate and a C-plate cooperating with a compensation value according to various preferred embodiment of the present invention.

### DETAILED DESCRIPTION OF THE PREFERRED EMBODIMENT

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

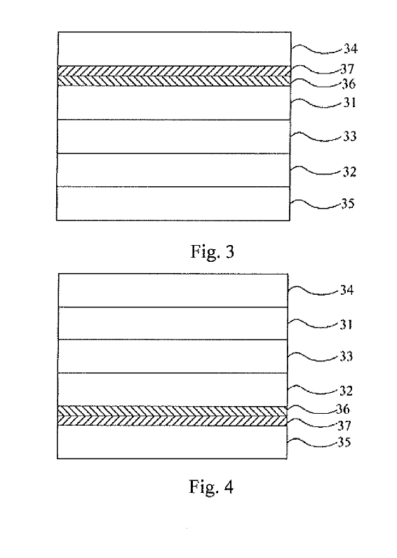

Please refer to FIG. 3, a structural diagram of the first preferred embodiment of LCD panels in the present invention.

The LCD of the embodiment in the present invention is preferably a vertical alignment (VA) LCD, whose optical path difference (OPD) LCΔND ranges 287 nm≦LCΔND≦305 nm, i.e. range [287 nm, 305 nm]; pretilt angle of the LCD ranges 85°≦Pretilt angle<90°, i.e. range [85°, 90°).

In the first embodiment as FIG. 3 indicates, the LCD comprises a first substrate 31, an uniaxial positively birefringent A-Plate 36, a liquid crystal layer 33, a first polarizing film 34, a second polarizing film 35, an uniaxial positively birefringent A-Plate 36 and an uniaxial negatively birefringent C-Plate 37. The liquid crystal layer 33 is set up between the first substrate 31 and the uniaxial positively birefringent A-Plate 36. The first polarizing film 34 is set up on the outside of the first substrate 31, and the second polarizing film 35 is set up on the outside of the uniaxial positively birefringent A-Plate 36.

In detailed embodiment, the uniaxial positively birefringent A-Plate 36 and the uniaxial negatively birefringent C-Plate 37 are set up on the same side of the liquid crystal layer, and set up between the first substrate 31 and the first polarizing film 34, or between the first substrate 31 and the second polarizing film 35.

In the first preferred embodiment as FIG. 3 indicates, the uniaxial positively birefringent A-Plate 36 and the uniaxial negatively birefringent C-Plate 37 are adhered, and set up between the first substrate 31 and the first polarizing film 34.

The uniaxial positively birefringent A-Plate 36 and the uniaxial negatively birefringent C-Plate 37 share a same slow axis, which is perpendicular to an absorption axis of the first polarizing film 34.

In the second preferred embodiment as FIG. 4 indicates, the uniaxial positively birefringent A-Plate 36 and the uniaxial negatively birefringent C-Plate 37 are adhered, and set up between the uniaxial positively birefringent A-Plate 36 and the second polarizing film 35. The uniaxial positively birefringent A-Plate 36 and the uniaxial negatively birefringent C-Plate 37 share a same slow axis, which is perpendicular to an absorption axis of the second polarizing film 35.

In the preferred embodiments of the LCD, the angle of the absorption film of the first polarizing film 34 is 0°, and the angle of the absorption film of the second polarizing film 35 is 90°. When the angle of the absorption film of the first polarizing film 34 is 90°, and the angle of the absorption film of the second polarizing film 35 is 0°, as long as it is guaranteed that the slow axises of the uniaxial positively birefringent A-Plate 36 and the uniaxial negatively birefringent C-Plate 37 are perpendicular to the absorption axis of the polarizing film on the same side with the liquid crystal layer 33 (i.e. the first polarizing film 34 or the second polarizing film 35), all the other embodiments can be applied to the present invention.

By setting different compensation values of the uniaxial positively birefringent A-Plate 36 and the uniaxial negatively birefringent C-Plate 37, the present invention simulates leakage light, and acquires corresponding compensation range according to simulation results.

To achieve best compensation, in the simulation process, firstly setting the angle of the slow axis of the uniaxial positively birefringent A-Plate 36 and the uniaxial negatively birefringent C-Plate 37 and the absorption axis of the corresponding polarizing film as 90°, meanwhile setting the liquid crystal pretilt angle of the LCD as range [85°, 90°); setting pre-twist angles of four quadrants as 45°, and setting the liquid crystal optical path difference (OPD) LCΔND as range [287 nm, 305 nm]; at the same time, the light source used in simulation is blue yttrium aluminum garnet (YGA) LED spectrum, whose central luminance is 100 nit, and light source distribution pattern is lambert distribution.

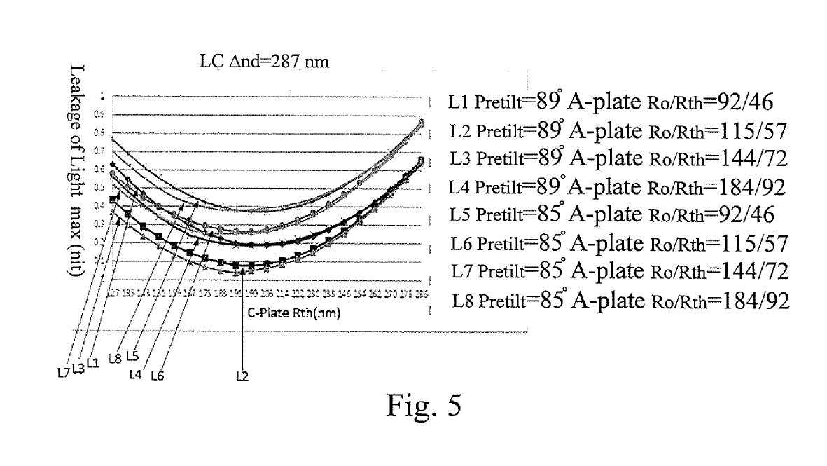

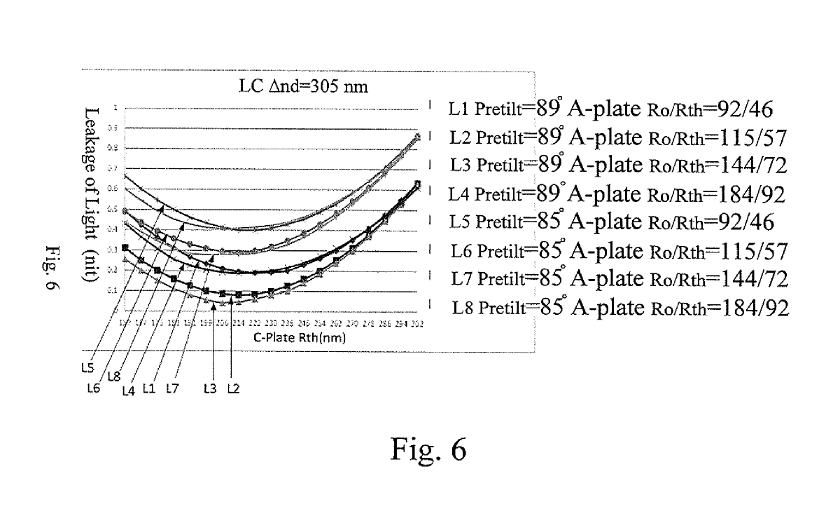

The simulation result is showed in FIG. 5 and FIG. 6, which indicate diagrams of curves of the changing amount of light leakage with retardation values. FIG. 5 indicates a diagram of the light leakage change when the OPD LCΔND is 287 nm, the pretilt angles are 89° and 85°, and when a in-plane retardation Ro and a thickness direction retardation Rth of the uniaxial positively birefringent A-Plate 36 and a thickness direction retardation Rth of the uniaxial negatively birefringent C-Plate 37 take different values. FIG. 6 indicates a diagram of the light leakage change when the OPD LCΔND is 305 nm, the pretilt angles are 89° and 85°, and when the in-plane retardation Ro and the thickness direction retardation Rth of the uniaxial positively birefringent A-Plate 36 and the thickness direction retardation Rth of the uniaxial negatively birefringent C-Plate 37 take different values. In FIG. 5 and FIG. 6, C-Plate Rth indicates the thickness direction retardation Rth of the uniaxial negatively birefringent C-Plate 37, A-Plate Ro indicates the in-plane retardation Ro of the uniaxial positively birefringent A-Plate 36, A-Plate Rth indicates the thickness direction retardation Rth of the uniaxial positively birefringent A-Plate 36.

Through the simulation above, it can be concluded that under different pretilt angles, the impact trend of the compensation of the uniaxial positively birefringent A-Plate 36 and the uniaxial negatively birefringent C-Plate 37 on the leakage light is identical. In other words, under different pretilt angles, the smallest leakage light's corresponding compensation ranges are the same. According to the simulation, when the liquid crystal OPD LCΔND ranges [287 nm, 305 nm] and the pretilt angle ranges [85°, 90°), leakage light is smaller than 0.2 nit (a simulated leakage light value when the pretilt angle is 89°, not a measured value), the corresponding retardation values of the uniaxial positively birefringent A-Plate—compensation film 36 and the uniaxial negatively birefringent C-Plate—compensation film 37 ranges as below:

The range of the in-plane OPD compensation Ro of the uniaxial positively birefringent A-Plate 36 is: 92 nm≦Ro≦184 nm, and the range of the out-plane OPD compensation Rth of the uniaxial positively birefringent A-Plate 36 is: 46 nm≦Rth≦92 nm. The range of the of compensation value Rth of the uniaxial negatively birefringent C-Plate 37 is Y1≦Rth≦Y2, where Y1 and Y2 satisfy formulas (1) and (2) as below:

Y1=−0.00003316x³+0.08074x²−10.84x+520.2 (1)

Y2=−0.00005073x⁴+0.013658x³−1.3931x²+63.85x−853.5 (2)

While formulas (1) and (2) as above is the out-plane OPD compensation Rth of the uniaxial positively birefringent A-Plate 36.

The compensation ranges above are stated in the following chart:

| | A-Plate | A-Plate | C-Plate |
|---|---|---|---|
| LCΔND | Ro | Rth | Rth |
| [287 nm, 305 nm] | [92 nm, 184 nm] | [46 nm, 92 nm] | [Y1 nm, Y2 nm] |

Specifically, the range s of the in-plane OPD compensation Ro and the out-plane OPD compensation Rth of the uniaxial positively birefringent A-Plate 36 are acquired through adjusting of the following formulas (3) and (4):

Ro=(Nx−Ny)*d1; (3)

Rth=[(Nx+Ny)/2−Nz]*d1; (4)

Whereof Nx is the highest refractivity which an in-plane of the uniaxial positively birefringent A-Plate 36 can provide in direction X; Ny is the refractivity of direction Y of the uniaxial positively birefringent A-Plate 36 with which direction X is perpendicular ( [symbol] ) with; Nz is the refractivity of the thickness direction of the uniaxial positively birefringent A-Plate 36; d1 is the thickness of the uniaxial positively birefringent A-Plate 36; Nx>Ny, Ny=Nz.

The range of the out-plane OPD compensation Rth of the uniaxial negatively birefringent C-Plate 37 can be acquired through the following formula (5):

Rth=[(Mx+My)/2−Mz]*d2; (5)

Whereof Mx is the highest refractivity which the in-plane of the uniaxial negatively birefringent C-Plate 37 can provide in direction X; My is the refractivity of direction Y of the uniaxial negatively birefringent C-Plate 37 with which direction X is perpendicular with; Mz is the refractivity of the thickness direction of the uniaxial negatively birefringent C-Plate 37; d2 is the thickness of the uniaxial negatively birefringent C-Plate 37; Mx=My, My>Mz.

The following embodiments A. B and C provide further illustration of how to adjust the uniaxial positively birefringent A-Plate 36 and the uniaxial negatively birefringent C-Plate 37 according to the formulas mentioned above.

(A): When refractivity Nx, Ny and Nz are given, adjust thickness d1 of the uniaxial positively birefringent A-Plate 36; according to formulas (3) and (4), adjust the range of the in-plane OPD compensation value Ro of the uniaxial positively birefringent A-Plate 36 as 92 nm≦Ro≦184 nm, meanwhile adjust the range of its out-plane OPD compensation value Rth as 46 nm≦Rth≦92 nm.

When refractivity Mx, My and Nz are given, adjust thickness d2 of the uniaxial negatively birefringent C-Plate 37; according to formula (5), adjust the range of the out-plane OPD compensation value Rth of the uniaxial negatively birefringent C-Plate 37 as Y1≦Rth≦Y2.

(B): When thickness d1 of the uniaxial positively birefringent A-Plate 36 is given, according to formulas (3) and (4), adjusting refractivity Nx, Ny and Nz of the uniaxial positively birefringent A-Plate 36; adjusting the range of the in-plane OPD compensation value of the uniaxial positively birefringent A-Plate 36 as: 92 nm≦Ro≦184 nm, meanwhile adjusting the range of its out-plane OPD compensation value as: 46 nm≦Rth≦92 nm. When thickness d2 of the uniaxial negatively birefringent C-Plate 37 is given, according to formulas (3) and (4), adjusting refractivity Mx, My and Mz of the uniaxial negatively birefringent C-Plate 37; adjusting the out-plane OPD compensation value of the range of the uniaxial negatively birefringent C-Plate 37 as: Y1≦Rth≦Y2.

(C): Firstly, adjusting the thickness d1 of the uniaxial positively birefringent A-Plate—compensation film 36 and refractivity Nx, Ny, Nz simultaneously; according to formulas (3) and (4), adjusting the range of the in-plane OPD compensation value Ro of the uniaxial positively birefringent A-Plate 36 as: 92 nm≦Ro≦184 nm, meanwhile adjusting the range of its out-plane OPD compensation value Rth as: 46 nm≦Rth≦92 nm; secondly, adjusting the thickness d2 of the uniaxial negatively birefringent C-Plate 37 and refractivity Mx, My, Mz simultaneously; according to formula (5), adjusting the range of the out-plane OPD compensation value of the uniaxial negatively birefringent C-Plate 37 as: Y1≦Rth≦Y2.

The following embodiments 1), 2) and 3) illustrate the technological effects of the present invention:

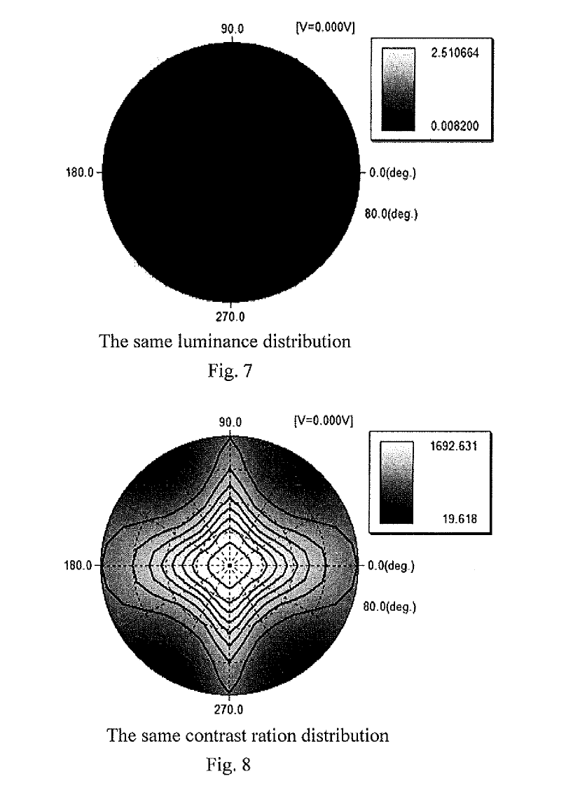

1) Setting liquid crystal OPD as LCΔND=296 nm, pretilt angle as 89°, the compensation value Ro of the uniaxial positively birefringent A-Plate film 36 as 144 nm, Rth=72 nm, and the compensation value Rth of the uniaxial negatively birefringent C-Plate 37 as 167 nm; FIG. 7 indicates the light leakage chart of the corresponding leakage light of the compensation value mentioned above, and FIG. 8 indicates the same contrast distribution chart of the corresponding full-view, where the compensation values mentioned above are charted as below:

| Liquid Crystal | Pretilt | A-plate | A-plate | C-plate | Highest Value of |
|---|---|---|---|---|---|
| OPD | Angle | Ro | Rth | Rth | Light leakage |
| 296 nm | 89° | 144 nm | 72 nm | 167 nm | 0.145 |

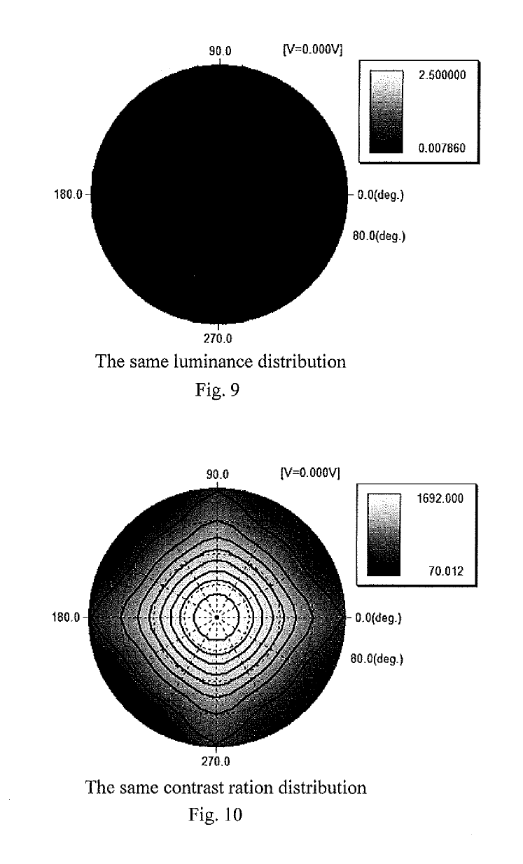

2) Setting liquid crystal OPD as LCΔND=296 nm, pretilt angle as 89°, the compensation value Ro of the uniaxial positively birefringent A-Plate 36 as 144 nm, Rth=72 nm, and the compensation value Rth of the uniaxial negatively birefringent C-Plate 37 as Rth=199 nm; FIG. 9 indicates the light leakage chart of the corresponding leakage light of the compensation value mentioned above, and FIG. 10 indicates the same contrast distribution chart of the corresponding full-view, where the compensation values mentioned above are charted as below:

| | | | | | Highest |
|---|---|---|---|---|---|
| Liquid Crystal | | A-plate | A-plate | C-plate | Value of |
| OPD | Pretilt Angle | Ro | Rth | Rth | Light leakage |
| 296 nm | 89° | 144 nm | 72 nm | 199 nm | 0.04 |

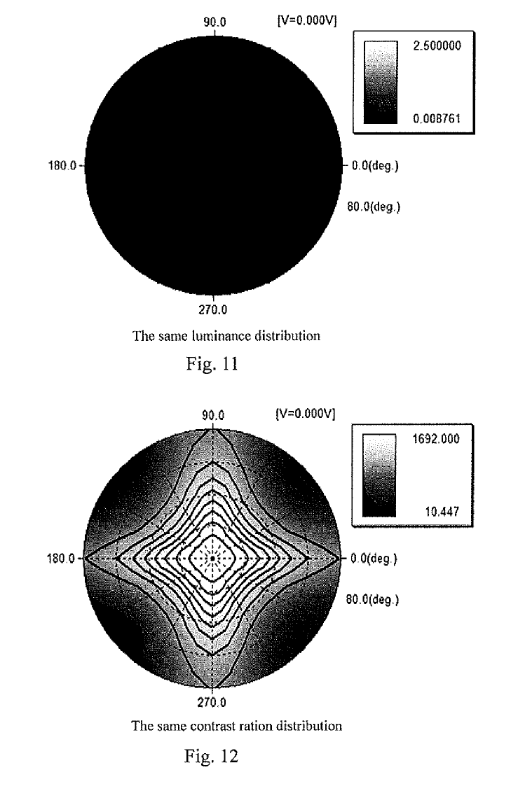

3) Setting liquid crystal OPD as LCΔND=296 nm, pretilt angle as 89°, the compensation value Ro of the uniaxial positively birefringent A-Plate 36 as 144 nm, Rth=72 nm, and the compensation value Rth of the uniaxial negatively birefringent C-Plate 37 as 238 nm; FIG. 11 indicates the light leakage chart of the corresponding leakage light of the compensation value mentioned above, and FIG. 12 indicates the same contrast distribution chart of the corresponding full-view, where the compensation values mentioned above are charted as below:

| | | | | | Highest |
|---|---|---|---|---|---|
| Liquid Crystal | Pretilt | A-plate | A-plate | C-plate | Value of |
| OPD | Angle | Ro | Rth | Rth | Light leakage |
| 296 nm | 89° | 144 nm | 72 nm | 238 nm | 0.147 |

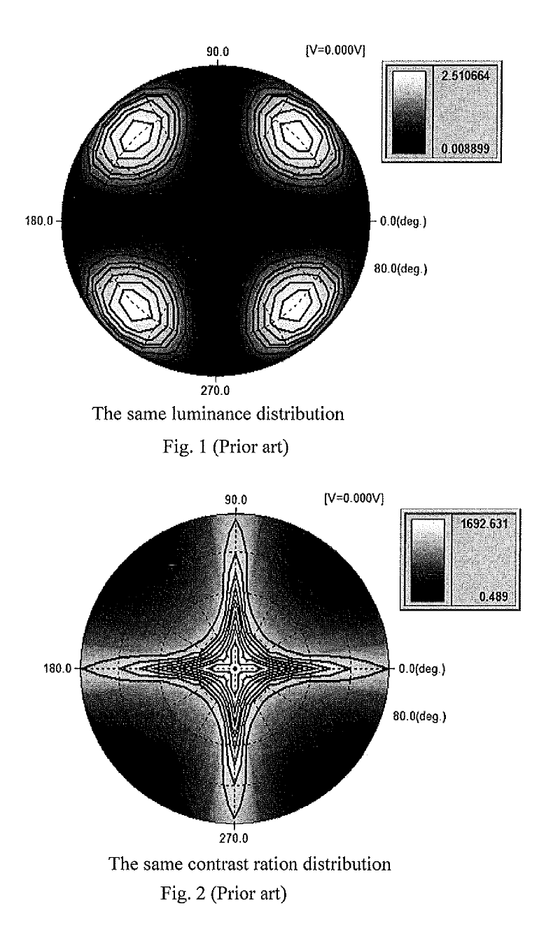

Compare light leakage effects diagram FIG. 7, FIG. 9 and FIG. 11 with effect diagram FIG. 1 of the conventional art, it can be concluded: if applying compensation values of the embodiments of the present invention, the highest leakage light of the uniaxial positively birefringent A-Plate 36 and the uniaxial negatively birefringent C-Plate 37 after compensation declines from 2.5 nit to 0.2 nit.

Compare full-view same contrast distribution effects diagram FIG. 8, FIG. 10 and FIG. 12 with effect diagram FIG. 2 of the conventional art, it can be concluded that if applying compensation values of the embodiments of the present invention, the full-view contrast distribution is better than that of the conventional art. Therefore, the present invention improve severe leakage light problem when applying compensation values of A-Plate and C-Plate, effectively raise contrast ratio and resolution under wide viewing angle.

The present invention also provides an optical compensation method using the LCD. The method particularly applies to a VA LCD. The range of the LCD's OPD is [287 nm, 305 nm], the range of its liquid crystal pretilt angle is [85°, 90°). The LCD comprises an uniaxial positively birefringent A-Plate 36 and an uniaxial negatively birefringent C-Plate 37, which are set up on the same side of the liquid crystal layer 33, and between the first substrate 31 and the first polarizing film 34, or between the second substrate 33 and the second polarizing film 35. Please refer to FIG. 3 and FIG. 4.

The optical compensation method for the LCD of the embodiment according to the present invention comprises:

(I) adjusting the range of the in-plane OPD compensation value of the uniaxial positively birefringent A-Plate 36 as 92 nm≦Ro≦184 nm; (II) adjusting the range of the out-plane OPD compensation value of the uniaxial positively birefringent A-Plate 36 as 46 nm≦Rth≦92 nm;

(III) adjusting the range of the compensation value Rth of the uniaxial negatively birefringent C-Plate 37 as Y1≦Rth≦Y2, where:

Y1=−0.00003316x³+0.08074x²−10.84x+520.2;

Y2=−0.00005073x⁴+0.013658x³−1.3931x²+63.85x−853.5;

X is the out-plane OPD compensation value Rth of the uniaxial positively birefringent A-Plate 36.

It is necessary to point out that the sequence of the above steps (I), (II) and (III) is changeable.

In practical process, adjusting the range of the in-plane OPD compensation value Ro of the uniaxial positively birefringent A-Plate 36 as 92 nm≦Ro≦184 nm, and adjust the range of the out-plane OPD compensation value Rth of the uniaxial positively birefringent A-Plate 36 as 46 nm≦Rth≦92 nm through the following formulas:

Ro=(Nx−Ny)*d1;

Rth=[(Nx+Ny)/2−Nz]*d1;

Whereof Nx is the highest refractivity which the in-plane of the uniaxial positively birefringent A-Plate 36 can provide in direction X; Ny is the refractivity of direction Y of the uniaxial positively birefringent A-Plate 36 with which direction X is perpendicular with; Nz is the refractivity of the thickness direction of the uniaxial positively birefringent A-Plate 36; d1 is the thickness of the uniaxial positively birefringent A-Plate 36; Nx>Ny, Ny=Nz.

In practical process, adjusting the range of the compensation value Rth of the uniaxial negatively birefringent C-Plate 37 as Y1≦Rth≦Y2 through the following formula:

Rth=[(Mx+My)/2−Mz]*d2;

where Mx is the highest refractivity which the in-plane of the uniaxial negatively birefringent C-Plate 37 can provide in direction X; My is the refractivity of direction Y of the uniaxial negatively birefringent C-Plate 37 with which direction X is perpendicular with; Mz is the refractivity of the thickness direction of the uniaxial negatively birefringent C-Plate 37; d2 is the thickness of the uniaxial negatively birefringent C-Plate 37; Mx=My, My>Mz.

As to practical adjusting of compensation values, please refer to concerned description above.

The embodiment of the present invention provides two optical compensation films with liquid crystal OPD LCΔND AS [287 nm, 305 nm] and liquid crystal pretilt angle as 185°, 90°): the uniaxial positively birefringent A-Plate 36 and the uniaxial negatively birefringent C-Plate 37. Through adjusting compensation values of the two compensation films, leakage light under wide viewing angle is weakened. Embodying the present invention effectively raises contrast ratio and resolution under wide viewing angle (non lateral and perpendicular wide viewing angle).

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A liquid crystal display (LCD) device, wherein a range of a liquid crystal optical path difference (OPD) LCΔND of the LCD is 287 nm≦LCΔND≦305 nm, and the LCD comprises:
a first substrate;
a second substrate;
a liquid crystal layer set up between the first substrate and the second substrate;
a first polarizing film set up on the outside of the first substrate;
a second polarizing film set up on the outside of the second substrate;
an uniaxial positively birefringent A-Plate; and
an uniaxial negatively birefringent C-Plate, the uniaxial positively birefringent A-Plate and the uniaxial negatively birefringent C-Plate set up between the first substrate and the first polarizing film, or between the second substrate and the second polarizing film;
where a range of an in-plane OPD compensation value Ro of the uniaxial positively birefringent A-Plate is 92 nm≦Ro≦184 nm, a range of an out-plane OPD compensation value Rth of the uniaxial positively birefringent A-Plate -is 46 nm≦Rth≦92 nm; a range of a compensation value of the uniaxial negatively birefringent C-Plate is Y1≦Rth≦Y2; where Y1 and Y2 satisfy the following formulas:
Y1=−0.00003316x³+0.08074x²−10.84x+520.2;
Y2=−0.00005073x⁴+0.013658x³−1.3931x²+63.85x−853.5;
X is the out-plane OPD compensation value Rth of the uniaxial positively birefringent A-Plate out-plane OPD compensation value Rth.

2. The LCD of claim 1, wherein the range of the in-plane OPD compensation value Ro of the uniaxial positively birefringent A-Plate and the range of the out-plane OPD compensation value Rth of the uniaxial positively birefringent A-Plate are acquired through the following formulas:
Ro=(Nx−Ny)*d1; and
Rth=[(Nx+Ny)/2−Nz]*d1
where Nx is the highest refractivity which an in-plane of the uniaxial positively birefringent A-Plate can provide in direction X; Ny is the refractivity of direction Y of the uniaxial positively birefringent A-Plate which direction X is perpendicular with; Nz is the refractivity of a thickness direction of the uniaxial positively birefringent A-Plate; d1 is the thickness of the uniaxial positively birefringent A-Plate; Nx>Ny, Ny=Nz.

3. The LCD of claim 1, wherein the range of the compensation value Rth of the uniaxial negatively birefringent C-Plate is acquired through the following formula:
Rth=[(Mx+My)/2−Mz]*d2;
where Mx is the highest refractivity which the in-plane of the uniaxial negatively birefringent C-Plate can provide in direction X; My is the refractivity of direction Y of the uniaxial negatively birefringent C-Plate which direction X is perpendicular with; Mz is the refractivity of the thickness direction of the uniaxial negatively birefringent C-Plate; d2 is the thickness of the uniaxial negatively birefringent C-Plate; Mx=My, My>Mz.

4. The LCD of claim 1, wherein the uniaxial positively birefringent A-Plate and the uniaxial negatively birefringent C-Plate are set up on the same side of the liquid crystal layer and between the first substrate and the first polarizing film.

5. The LCD of claim 1, wherein the uniaxial positively birefringent A-Plate and the uniaxial negatively birefringent C-Plate are set up on the same side of the liquid crystal layer, and between the second substrate and the second polarizing film.

6. A liquid crystal display (LCD) device, comprising:
a first substrate;
a second substrate;
a liquid crystal layer set up between the first substrate and the second substrate;
a first polarizing film set up on the outside of the first substrate;
a second polarizing film set up on the outside of the second substrate;
an uniaxial positively birefringent A-Plate; and
an uniaxial negatively birefringent C-Plate, the uniaxial positively birefringent A-Plate and the uniaxial negatively birefringent C-Plate set up between the first substrate and the first polarizing film, or between the second substrate and the second polarizing film;
where a range of an in-plane OPD compensation value Ro of the uniaxial positively birefringent A-Plate is 92 nm≦Ro≦184 nm, a range of an out-plane OPD compensation value Rth of the uniaxial positively birefringent A-Plate -is 46 nm≦Rth≦92 nm; a range of a compensation value of the uniaxial negatively birefringent C-Plate is Y1≦Rth≦Y2; where Y1 and Y2 satisfy the following formulas:
Y1=−0.00003316x³+0.08074x²−10.84x+520.2;
Y2=−0.00005073x⁴+0.013658x³−1.3931x²+63.85x−853.5;
X is the out-plane OPD compensation value Rth of the uniaxial positively birefringent A-Plate out-plane OPD compensation value Rth.

7. The LCD of claim 6, wherein the range of the in-plane OPD compensation value Ro of the uniaxial positively birefringent A-Plate and the range of the out-plane OPD compensation value Rth of the uniaxial positively birefringent A-Plate are acquired through the following formulas:
Ro=(Nx−Ny)*d1; and
Rth=[(Nx+Ny)/2−Nz]*d1
where Nx is the highest refractivity which an in-plane of the uniaxial positively birefringent A-Plate can provide in direction X; Ny is the refractivity of direction Y of the uniaxial positively birefringent A-Plate which direction X is perpendicular with; Nz is the refractivity of a thickness direction of the uniaxial positively birefringent A-Plate; d1 is the thickness of the uniaxial positively birefringent A-Plate; Nx>Ny, Ny=Nz.

8. The LCD of claim 6, wherein the range of the compensation value Rth of the uniaxial negatively birefringent C-Plate is acquired through the following formula:
Rth=[(Mx+My)/2−Mz]*d2;
where Mx is the highest refractivity which the in-plane of the uniaxial negatively birefringent C-Plate can provide in direction X; My is the refractivity of direction Y of the uniaxial negatively birefringent C-Plate which direction X is perpendicular with; Mz is the refractivity of the thickness direction of the uniaxial negatively birefringent C-Plate; d2 is the thickness of the uniaxial negatively birefringent C-Plate; Mx=My, My>Mz.

9. The LCD of claim 6, wherein the uniaxial positively birefringent A-Plate and the uniaxial negatively birefringent C-Plate are set up on the same side of the liquid crystal layer and between the first substrate and the first polarizing film.

10. The LCD of claim 6, wherein the uniaxial positively birefringent A-Plate and the uniaxial negatively birefringent C-Plate are set up on the same side of the liquid crystal layer, and between the second substrate and the second polarizing film.

11. An optical compensation method for an LCD, comprising:
adjusting a range of an in-plane OPD compensation value of a uniaxial positively birefringent A-Plate as 92 nm≦Ro≦184 nm;
adjusting a range of an out-plane OPD compensation value of an uniaxial positively birefringent A-Plate as 46 nm≦Rth≦92 nm; and
adjusting a range of a compensation value Rth of an uniaxial negatively birefringent C-Plate as Y1≦Rth≦Y2, where Y1 and Y2 satisfy the following formulas:
Y1=−0.00003316x³+0.08074x²−10.84x+520.2; and
Y2=−0.00005073x⁴+0.013658x³−1.3931x²+63.85x−853.5;
where X is the out-plane OPD compensation value Rth of the uniaxial positively birefringents A-Plate; the uniaxial positively birefringent A-Plate and the uniaxial negatively birefringent C-Plate are set up between the second substrate and the second polarizing film.

12. The optical compensation method of claim 11, wherein the range of the in-plane OPD compensation value Ro of the uniaxial positively birefringent A-Plate and the range of the out-plane OPD compensation value Rth of the uniaxial positively birefringent A-Plate are acquired through the following formulas:
Ro=Nx−Ny)*d1; and
Rth=[(Nx+Ny)/2−Nz]*d1
where Nx is the highest refractivity which an in-plane of the uniaxial positively birefringent A-Plate can provide in direction X; Ny is the refractivity of direction Y of the uniaxial positively birefringent A-Plate which direction X is perpendicular with; Nz is the refractivity of a thickness direction of the uniaxial positively birefringent A-Plate; d1 is the thickness of the uniaxial positively birefringent A-Plate; Nx>Ny, Ny=Nz.

13. The optical compensation method of claim 11, wherein the range of the compensation value Rth of the uniaxial negatively birefringent C-Plate is acquired through the following formula:
Rth=[(Mx+My)/2−Mz]*d2;
where Mx is the highest refractivity which the in-plane of the uniaxial negatively birefringent C-Plate can provide in direction X; My is the refractivity of direction Y of the uniaxial negatively birefringent C-Plate which direction X is perpendicular with; Mz is the refractivity of the thickness direction of the uniaxial negatively birefringent C-Plate; d2 is the thickness of the uniaxial negatively birefringent C-Plate; Mx=My, My>Mz.

14. The optical compensation method of claim 11, wherein the uniaxial positively birefringent A-Plate and the uniaxial negatively birefringent C-Plate are set up on the same side of the liquid crystal layer and between the first substrate and the first polarizing film.

15. The optical compensation method of claim 11, wherein the uniaxial positively birefringent A-Plate and the uniaxial negatively birefringent C-Plate are set up on the same side of the liquid crystal layer, and between the second substrate and the second polarizing film.
